(19) United States
(12) Patent Application Publication
(10) Pub. No.: US 2024/0385006 A1
(43) Pub. Date: Nov. 21, 2024

(54) NAVIGATION GUIDE USING DIFFERENT VEHICLE COMPONENTS

(71) Applicant: INTERNATIONAL BUSINESS MACHINES CORPORATION, ARMONK, NY (US)

(72) Inventors: Robert John Moore, San Jose, CA (US); Guangjie Ren, Belmont, CA (US); Chung-hao Tan, San Jose, CA (US); Alice Yoonjeong Lee, Cupertino, CA (US); Pengyuan Li, San Jose, CA (US)

(21) Appl. No.: 18/319,660

(22) Filed: May 18, 2023

(51) Int. Cl. G01C 21/36; B60W 50/16

(52) U.S. Cl. CPC G01C 21/3691; B60W 50/16; G01C 21/3629

(57) ABSTRACT

A method for automatically providing real-time navigation directions using one or more vehicle components is provided. The method may further include, in response to receiving and identifying navigation direction data from a navigation service provider, converting the navigation direction data into different electrical communications to different vehicle components that may include one or more combinations of a light indicator component, a sound indicator component, and a vibration indicator component associated with a vehicle. The method may also include automatically presenting the real-time navigation directions using the different vehicle components by automatically transmitting the electrical communications based on the navigation direction data to the one or more combinations of the light indicator component, the sound indicator component, and the vibration indicator component.

### BACKGROUND

The present invention relates generally to the field of computing, and more specifically, to a navigation system using a combination of vehicle components, including a light component, sound component, and vibration component, to provide real-time navigation to a driver/user.

Generally, an automotive navigation system may be associated with automobile controls or a third-party add-on that is used to find map direction for an automobile. Typically, automotive navigation systems use a satellite navigation device to get vehicle position data which is then correlated to a position on a road. When directions are needed, routes can be determined and calculated using real-time traffic information (road closures, congestion, etc.) that can also be used to adjust routes as well. More specifically, navigation systems use the Global Navigation Satellite System (GNSS) network to pinpoint a location of a vehicle, and the navigation system in the vehicle communicates with these satellites via microwaves to then display the vehicle's location on a screen that includes a geographical map. Vehicle location can then be monitored on the map as the vehicle moves, displayed in relation to nearby landmarks such as hotels, gas stations, or restaurants, and used to calculate the routes to destinations.

### SUMMARY

A method for automatically providing real-time navigation directions using one or more vehicle components is provided. The method may further include, in response to receiving and identifying navigation direction data from a navigation service provider, converting the navigation direction data into different electrical communications to different vehicle components that may include one or more combinations of a light indicator component, a sound indicator component, and a vibration indicator component associated with a vehicle. The method may also include automatically presenting the real-time navigation directions using the different vehicle components by automatically transmitting the electrical communications based on the navigation direction data to the one or more combinations of the light indicator component, the sound indicator component, and the vibration indicator component.

A computer system for automatically providing real-time navigation directions using one or more vehicle components is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may further include, in response to receiving and identifying navigation direction data from a navigation service provider, converting the navigation direction data into different electrical communications to different vehicle components that may include one or more combinations of a light indicator component, a sound indicator component, and a vibration indicator component associated with a vehicle. The method may also include automatically presenting the real-time navigation directions using the different vehicle components by automatically transmitting the electrical communications based on the navigation direction data to the one or more combinations of the light indicator component, the sound indicator component, and the vibration indicator component.

A computer program product for automatically providing real-time navigation directions using one or more vehicle components is provided. The computer program product may include one or more computer-readable storage devices and program instructions stored on at least one of the one or more tangible storage devices, the program instructions executable by a processor. The computer program product may include program instructions to, in response to receiving and identifying navigation direction data from a navigation service provider, convert the navigation direction data into different electrical communications to different vehicle components that may include one or more combinations of a light indicator component, a sound indicator component, and a vibration indicator component associated with a vehicle. The computer program product may also include program instructions to automatically present the real-time navigation directions using the different vehicle components by automatically transmitting the electrical communications based on the navigation direction data to the one or more combinations of the light indicator component, the sound indicator component, and the vibration indicator component.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to one embodiment;

FIG. 2 is an operational flowchart for a program for automatically providing real-time navigation directions using one or more vehicle components according to one embodiment;

FIG. 3A is an example diagram of a vehicle interior including vehicle components associated with a program for automatically providing real-time navigation directions using the vehicle components according to one embodiment;

FIG. 3B is another example diagram of a vehicle interior including vehicle components associated with a program for automatically providing real-time navigation directions using the vehicle components according to one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to automatically generating and providing real-time navigation directions using different vehicle components. Specifically, the present invention may improve the technical field associated with vehicle navigation systems by providing simpler and more efficient navigational tools for providing navigation directions to a user as opposed to the traditional map-based displays and voice directions associated with traditional vehicle navigation systems. For example, the present invention may receive navigation direction data from a navigation service (e.g., Google Maps®, Apple Maps®, Honda®, etc.; Google Maps and all Google-based trademarks and logos are trademarks or registered trademarks of Google, Inc. and/or its affiliates, Apple Maps and all Apple-based trademarks and logos are trademarks or registered trademarks of Apple, Inc. and/or its affiliates and Honda and all Honda-based trademarks and logos are trademarks or registered trademarks of Honda Motor Co. Ltd. and/or its affiliates), translate/convert the navigation direction data into different electrical communications to vehicle components that may include one or more combinations of a light indicator component, a sound indicator component, and a vibration indicator component, as well as translate/convert audio content and displayable content associated with the navigation direction data into more simplified audio content and displayed content. Thereafter, the present invention may provide real-time navigation directions to a user by transmitting/relaying the different electrical communications based on the navigation direction data to the corresponding vehicle components that may include the one or more combinations of the light indicator component, the sound indicator component, and the vibration indicator component, as well as may present the simplified audio content and displayed content similarly corresponding to the navigation direction data. As such, and in turn, the present invention may significantly reduce traditional cognitive computing loads, computer as well as driver processing required in presenting traditional map-based and voice navigation directions by transforming instructions from a navigation service into communications from light, sound, vibration and simpler digital display indicators.

As previously described with respect to vehicle navigation systems, current vehicle navigation systems may include a navigation interface that may display a vehicle's location on a geographical map that appears on a vehicle's screen. The vehicle location can then be monitored on the navigation interface as the vehicle moves in relation to landmarks such as streets, hotels, gas stations, and restaurants which may be depicted on the geographical map, and routes to different destinations may further be calculated using the navigation interface. However, current navigation interfaces may distract drivers from the road. Specifically, navigation systems including map-based displays may be distracting and complicated due to an overwhelming amount of landmarks as well as other map components and controls that may be displayed on the navigation interface that includes the geographical map. Similarly, voice directions are complex and may require an overwhelming amount of cognitive data to be loaded by the navigation interface in order to provide turn-by-turn directions that further includes overly inclusive landmark descriptions such as road and street descriptions (i.e. “take the right two lanes to turn right on San Tomas Expressway” or “in one thousand feet, go straight to stay on I-88 north”). As such, to improve upon current navigation systems, the present invention may provide a simpler and more streamlined process for presenting navigation direction to a user based on a combination of electrical communications to vehicle components that may include a combination of lighting, sound, and vibration indicators as well as provide simpler verbal and displayable directions on a vehicle's screen.

For example, and as previously described, the present invention may include a method, system, and computer program product for receiving and identifying navigation direction data from a navigation service. Then, in response to receiving and identifying the navigation direction data, the method, system, and computer program product may translate/convert the navigation direction data into different electrical communications to different vehicle components that may include one or more combinations of a light indicator component, a sound indicator component, and a vibration indicator component, as well as may translate/convert audio content and displayable content associated with the navigation direction data into a reduced form of audio content and displayed content. Next, the method, system and computer program product may provide real-time navigation directions to a driver/user by transmitting/relaying the electrical communications based on the navigation direction data to the one or more combinations of the light indicator component, the sound indicator component, and the vibration indicator component, as well as may present the reduced form of audio content and displayed content corresponding to the navigation direction data along with the electrical communications.

The present invention may be a system, a method, and/or a computer program product at any possible technical detail level of integration. The computer program product may include a computer readable storage medium (or media) having computer readable program instructions thereon for causing a processor to carry out aspects of the present invention.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine whether directional input is received along with a query and, accordingly, adjust presented display content to include a referenced object in a center of a screen of a primary device.

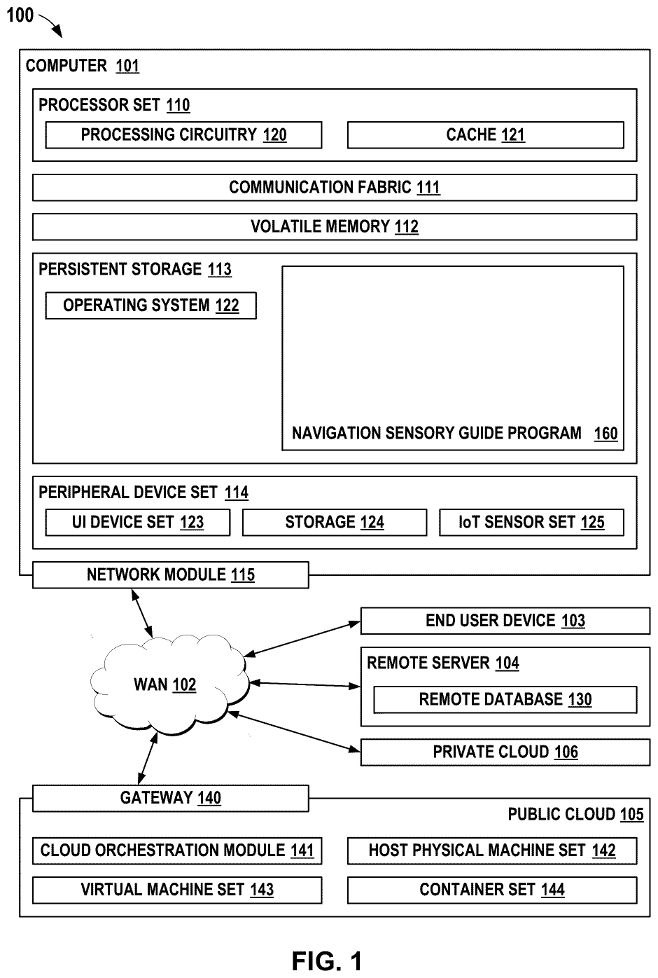

Referring to FIG. 1, an exemplary computing environment 100 is depicted, according to at least one embodiment. Computing environment 100 contains an example of an environment for the execution of at least some of the computer code involved in performing the inventive methods, such as a navigation sensory guide program 160. In addition to block 160, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 160, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer (such as a wearable headset), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 160 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 160 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles, headsets, and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector and/or accelerometer.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the navigation sensory guide program 160 may be a program/code capable of automatically providing real-time navigation directions using one or more vehicle components. Specifically, the navigation sensory guide program 160 may receive and identify navigation direction data from a navigation service. Then, in response to receiving and identifying the navigation direction data, the navigation sensory guide program 160 may translate/convert the navigation direction data into different electrical communications to different vehicle components that may include one or more combinations of a light indicator component, a sound indicator component, and a vibration indicator component, as well as may translate/convert audio content and displayable content associated with the navigation direction data into a reduced form of audio content and displayed content. Next, the navigation sensory guide program 160 may provide real-time navigation directions to a driver/user by transmitting/relaying the electrical communications based on the navigation direction data to the one or more combinations of the light indicator component, the sound indicator component, and the vibration indicator component, as well as may present the reduced form of audio content and displayed content corresponding to the navigation direction data along with the electrical communications.

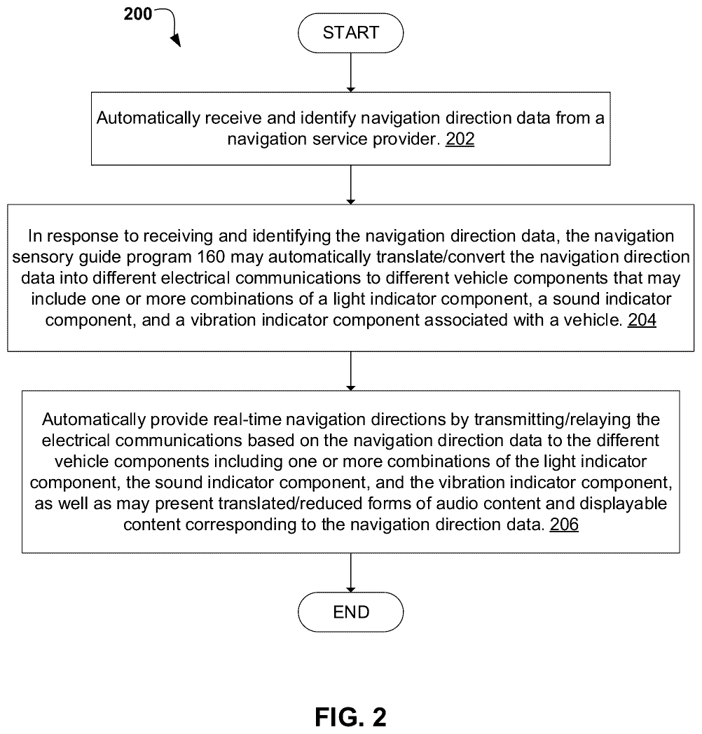

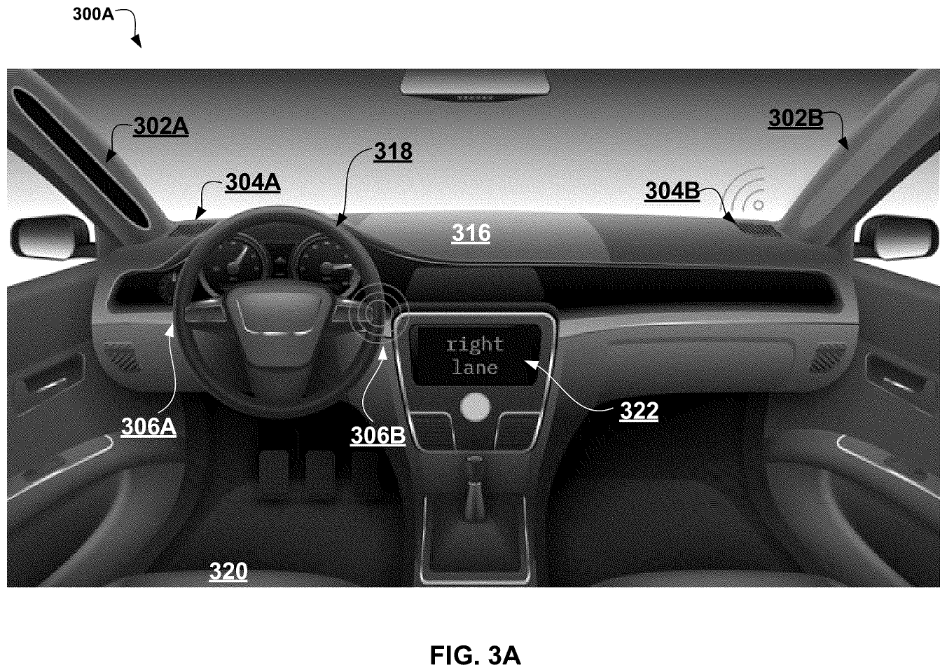

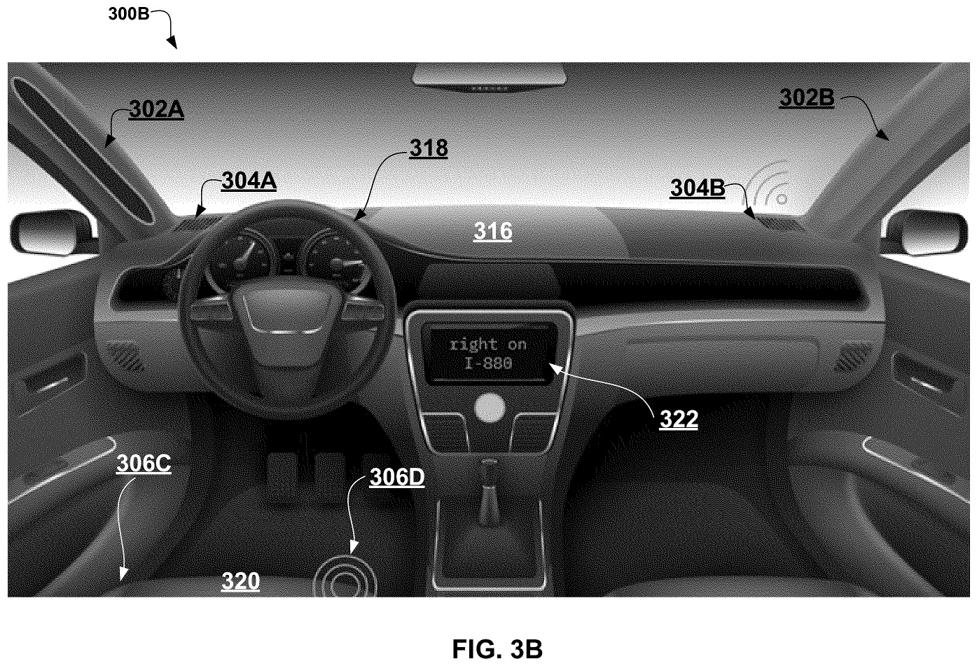

Furthermore, notwithstanding depiction in computer 101, the navigation sensory guide program 160 may be stored in and/or executed by, individually or in any combination, with end user device 103, remote server 104, public cloud 105, and private cloud 106. The navigation sensory guide program is explained in further detail below with respect to FIGS. 2-3B.

Referring now to FIG. 2, an operational flowchart 200 associated with a program for automatically providing real-time navigation directions using one or more vehicle components according to one embodiment is depicted. The operational flowchart 200 will further be described with reference to FIGS. 3A and 3B. According to one embodiment, and as depicted at 202, the navigation sensory guide program 160 may automatically receive and identify navigation direction data from a navigation service provider. For example, using a computing device such as mobile phone or an in-vehicle navigation computer system (each of which may be represented by computer 101 in FIG. 1), a driver/user may access a navigation service provider such as Google Maps® and enter a destination into Google Maps® to request navigation directions to a destination. In turn, the navigation service provider may provide navigation directions whereby the navigation directions may include navigation direction data. More specifically, for example, the navigation direction data may include data such as route information, turn-by-turn direction data, estimated distance between turns and roads data as well as distance to the destination, estimated time of arrival, road/street names, road condition information, and any other information that may be related to navigating a vehicle to the destination. In turn, the navigation sensory guide program 160 may receive the navigation direction data from the navigation service provider as well as may identify the navigation direction data using, for example, natural language processing and/or machine learning. For example, the navigation sensory guide program 160 may include natural language processing and/or machine learning algorithms to identify and interpret the instruction “in 1000 feet, take the right 2lanes to turn right onto I-880,” as being an instruction to turn right in 1000 feet.

Next, at 204, in response to receiving and identifying the navigation direction data, the navigation sensory guide program 160 may automatically translate/convert the navigation direction data into different electrical communications to different vehicle components that may include one or more combinations of a light indicator component, a sound indicator component, and a vibration indicator component associated with a vehicle. Furthermore, the navigation sensory guide program 160 may translate/convert audio content and displayable content associated with the identified and received navigation direction data into a second type, or alternative type, of audio content and displayed content that may include simpler, more reduced forms of audio content and displayed. Specifically, according to one embodiment and as depicted in example vehicle interiors 300A and 300B in FIGS. 3A and 3B, respectively, the navigation sensory guide program 160 may be integrated with a computer 101 (FIG. 1), which may be an in-vehicle computer system, and may further include or be integrated with vehicle components such as the light indicator component depicted at 302A, 302B, the sound indicator component depicted at 304A, 304B, and the vibration indicator component depicted at 306A and 306B in FIG. 3A and 306C and 306D in FIG. 3B.

More specifically, and according to one embodiment, the light indicator component 302A, 304B may include one or more light emitting devices that may emit light at various levels of brightness (as may be measured by lumens) to indicate distance from an upcoming turn. For example, and as depicted in FIGS. 3A and 3B, the light indicator component 302A, 302B may include 2 light emitting devices that may include a first light emitting device 302A positioned at a leftmost side panel above a vehicle dashboard 316 and a second lighting 302B device that may be positioned at a rightmost side panel above the vehicle dashboard 316. According to one embodiment, and as will be further described, the first light emitting device 302A positioned at the leftmost side panel above the vehicle dashboard 316 may indicate that a left turn may be approaching by emitting light in accordance with the navigation direction data identified and received at step 202. Similarly, the second light emitting device 302B positioned at the rightmost side panel above the vehicle dashboard 316 may indicate that a right turn may be approaching by emitting light based on the identified and received navigation direction data. According to another embodiment, the light emitting devices 302A, 302B may include portable light emitting devices such that the light emitting devices may be attached and detached, and/or connected and disconnected, to a vehicle and/or to in-vehicle computer system. According to another embodiment, the light indicator component may be a single light emitting device (not shown) that may be positioned in, on, or across a dashboard 316, whereby the single light emitting device may emit light at different parts of the dashboard 316 and/or different parts of the single light emitting device (i.e. at a leftmost side of the light emitting device to indicate a left turn and at a rightmost side of the light emitting device to indicate a right turn).

In any position, and as previously described, the light indicator component 302A, 304B may include one or more light emitting devices that may emit light at various levels of brightness (as may be measured by lumens) to indicate a distance from an upcoming turn. As previously described, in response to receiving and identifying the navigation direction data, the navigation sensory guide program 160 may translate/convert the navigation direction data into different electrical communications to different vehicle components that may include the light indicator component 302A, 304A. More specifically, the electrical communications may include programming/code that may include an electrical alert and/or prompt for a vehicle component to perform a certain way. For example, based on entry of a destination using a mobile device or in-vehicle computer system, a navigation service provider may provide navigation direction data that may include an instruction such as “in 1000 feet, take the right 2 lanes to turn right onto I-880.” As such, and according to one embodiment, the navigation sensory guide program 160 may include programming/code to convert the instruction direction into electrical communications to the vehicle components such as the light indicator component 302A, 302B, whereby the electrical communication may include programming/code for a certain light emitting device to emit light at a certain lumens level based on the distance to the right turn.

In a further example, the navigation sensory guide program 160 may include natural language processing and/or machine learning algorithms to identify and interpret the instruction “in 1000 feet, take the right 2 lanes to turn right onto I-880,” as being an instruction to turn right in 1000 feet. According to one embodiment, the navigation sensory guide program 160 may include programming/code to specifically associate a right turn with a rightmost light emitting device which may include the second light emitting device 302B in FIGS. 3A and 3B as previously described above. Conversely, the navigation sensory guide program 160 may include programming/code to specifically associate a left turn with a leftmost light emitting device which may include the first light emitting device 302A in FIGS. 3A and 3B as previously described above. Furthermore, the navigation sensory guide program 160 may include programming/code to associate a certain distance with a certain level of brightness (which again, may be measured in lumens) for a light emitting device. For example, the navigation sensory guide program 160 may include programming/code to associate a distance of 1000 feet with a certain lumens level or brightness that is greater or brighter than the lumens level associated with a distance of 1 mile due to a turn that is in 1000 feet being closer in distance than a turn in 1 mile. In other words, the navigation sensory guide program 160 may directly correlate the brightness of a light emitting device with a distance to an upcoming turn based on the navigation direction data to indicate that distance to the turn, whereby as a vehicle approaches or as the distance decreases (or becomes within a threshold distance) to the turn then the brighter the light emitting device becomes to indicate that the vehicle is getting closer to the turn.

For example, the navigation sensory guide program 160 may include natural language processing and/or machine learning to identify and interpret a real-time first navigation direction, “in 1 mile, take the right 2 lanes to turn right onto I-880,” as making an instruction to turn right in 1 mile. Accordingly, and as depicted in FIG. 3A, the navigation sensory guide program 160 may include programming/code for generating an electrical communication to specifically emit light from the rightmost light emitting device, which may include the second light emitting device 302B, to indicate a right turn. Furthermore, the navigation sensory guide program 160 may include programming/code to associate a distance of 1 mile with a lumens level of 600, and therefore, the electrical communication may further include programming/code to specifically emit light from the second light emitting device 302B at a lumens level of 600 based on the first navigation direction, “in 1 mile, take the right 2 lanes to turn right onto I-880.” Thereafter, the navigation sensory guide program 160 may identify and interpret a real-time second navigation direction that includes “in 1000 feet, take the right 2 lanes to turn right onto I-880,” to indicate that the vehicle is getting closer to the right turn. Accordingly, the navigation sensory guide program 160 may include programming/code to associate the distance of 1000 feet with a lumen level of 1000, and therefore, may generate an electrical communication to specifically increase the brightness of the light emitted from the second light emitting device 302B from 600 lumens to 1000 lumens based on the second navigation direction, “in 1000 feet, take the right 2 lanes to turn right onto I-880.” According to one embodiment, and further based on the above example, the navigation sensory guide program 160 may also incrementally increase the lumen level of the second light emitting device 302B for each distance in between 1 mile and 1000 feet, such as by incrementally increasing the brightness from 600 lumens (1 mile), to 700 lumens (0.75 mile), to 800 lumens (0.50 mile), to 900 lumens (0.25), to 1000 lumens (1000 feet) etc., to further indicate that the vehicle is getting closer to a turn Therefore, the navigation sensory guide program 160 may include programming/code to associate different distances with different levels of brightness, whereby the navigation sensory guide program 160 may increase the brightness of a light emitting device as a vehicle gets closer in distance to a turn. Additionally, in response to the navigation sensory guide program 160 detecting that the vehicle reaches a turn (such as by detecting that a vehicle is within 100 feet of a turn based on the navigation direction data), then the navigation sensory guide program 160 may generate an electrical communication to the second light emitting device 302B until the distance reaches 0 feet, whereby that electrical communication may further increase/intensify the brightness as well as emits flashing light, whereby generating the electric alert for the second light emitting device 314C to emit flashing light may include programming/code to emit light at least 3 times per second to cause the light emitting device to flash and/or provide a sequence/pattern of light. The above example provides only illustration of one implementation of the light indicator component 302A, 302B and does not imply any limitations with regard to how different embodiments may be implemented with respect to the position, number of vehicle components, and association between distances and brightness of light.

In addition to the light indicator component 302A, 302B, and as previously described, the navigation sensory guide program 160 may be integrated with a vehicle component such as the sound indicator component 304A, 304B which may also be associated/integrated with the in-vehicle computer system. According to one embodiment, the sound indicator component 304A, 304B may include an audio system associated with a vehicle as depicted in FIGS. 3A and 3B. According to another embodiment, the sound indicator component may include an audio system associated with a user's mobile device (not shown), such as a mobile phone. Furthermore, similar to the light indicator component 302A, 302B, the sound indicator component 304A, 304B may include one or more sound emitting devices, such as speakers 304A, 304B, that may emit sound at different volumes (as may be measured by decibels) and/or emit sound a different amount of times to indicate distance from an upcoming turn based on the navigation direction data. For example, and as depicted in FIGS. 3A-3C, the sound indicator component 304A, 304B may include at least 2 sound emitting devices that may include a first speaker 304A positioned at a leftmost side atop a vehicle dashboard 316 and a second speaker 304B that may be positioned at a rightmost side atop the vehicle dashboard 316. According to one embodiment, and as will be further described, the first speaker 304A positioned at the leftmost side atop the vehicle dashboard 316 may indicate that a left turn may be approaching by emitting sound based on the navigation direction data identified and received at step 202. Similarly, the second speaker 304B positioned at the rightmost side atop the vehicle dashboard 316 may indicate that a right turn may be approaching by emitting sound based on the identified and received navigation direction data. According to another embodiment, the sound indicator component may be a single sound emitting device that may be positioned in, on, or across a dashboard 316, whereby the single sound emitting device may emit sound to indicate a turn.

At any position, and as previously described, the sound indicator component 304A, 304B may include one or more sound emitting devices such as speakers that may emit sound at various volumes and/or times to indicate a distance from an upcoming turn. Specifically, and as previously described with reference to the above example, in response to receiving and identifying the navigation direction data, the navigation sensory guide program 160 may translate/convert the navigation direction data into different electrical communications to different vehicle components that may include the light indicator component 302A, 302B (as described above) as well as the sound indicator component 304A, 304B. For example, and as previously described, based on entry of a destination using a mobile device or in-vehicle computer system, a navigation service provider may provide navigation direction data that may include a direction such as “in 1000 feet, take the right 2 lanes to turn right onto I-880.” As such, and according to one embodiment, the navigation sensory guide program 160 may include programming/code to concurrently convert the instruction/direction into electrical communications to the light indicator component 302A, 302B (described above) as well as for the sound indicator component 304A, 304B, whereby the electrical communication for the sound indicator component 304A, 304B may include programming/code for a particular sound emitting device to emit sound at a certain decibel level and/or emit a certain amount of sounds based on the distance to the right turn.

More specifically, for example, the navigation sensory guide program 160 may include natural language processing and/or machine learning to identify and interpret the instruction, “in 1000 feet, take the right 2 lanes to turn right onto I-880,” as an instruction to turn right in 1000 feet. Accordingly, the navigation sensory guide program 160 may include programming/code to specifically associate a right turn with a rightmost sound emitting device which may include the second speaker 304B in FIGS. 3A and 3B as previously described above. Conversely, the navigation sensory guide program 160 may include programming/code to specifically associate a left turn with a leftmost sound emitting device which may include the first speaker 304A in FIGS. 3A and 3B as previously described above. Furthermore, the navigation sensory guide program 160 may include programming/code to associate a distance associated with a turn with a certain volume of sound and/or with a certain number of sounds for the sound emitting device. For example, the navigation sensory guide program 160 may include programming/code to associate a distance of 1000 feet with a certain decibel level that is greater or louder than the decibel level associated with a distance of 1 mile due to a turn that is in 1000 feet being closer in distance than a turn in 1 mile. In other words, the navigation sensory guide program 160 may directly correlate the volume of a sound emitting device with a distance to an upcoming turn based on the navigation direction data to indicate the distance of the upcoming turn, whereby as a vehicle approaches or the distance decreases to a turn then the sound volume from the sound emitting device may increase to indicate that the vehicle is getting closer to the turn. Additionally, or alternatively, the navigation sensory guide program 160 may include programming/code to associate a distance of 1000 feet with a certain number of sounds generated at one time (for example, 3 “beeps” within 1.5 seconds) that is greater than the number of sounds associated with a distance of 1 mile (2 “beeps” within 1.5 seconds) due to a turn that is in 1000 feet being closer in distance than a turn in 1 mile. In other words, the navigation sensory guide program 160 may directly correlate the number of sounds emitted at one time from the sound emitting device with a distance to an upcoming turn derived from the navigation direction data to indicate the distance from the upcoming turn (or closeness in distance), whereby as a vehicle approaches or the distance decreases to the upcoming turn then the number sounds emitted from the sound emitting device may increase to indicate that the vehicle is getting closer to the upcoming turn.

For example, the navigation sensory guide program 160 may include natural language processing and/or machine learning to identify and interpret a real-time first navigation direction, “in 1 mile, take the right 2 lanes to turn right onto I-880,” as making an instruction to turn right in 1 mile. Accordingly, and as depicted in FIG. 3C, the navigation sensory guide program 160 may include programming/code for generating an electrical communication to specifically emit sound from the rightmost sound emitting device, which may include the second speaker 304B, to indicate a right turn. Furthermore, the navigation sensory guide program 160 may include programming/code to associate a distance of 1 mile with a certain decibel level and/or with a certain number of sounds (i.e. 2 “beeps”), and therefore, the electrical communication may further include programming/code to specifically emit a sound of 2 “beeps” from the second speaker 304B at a corresponding decibel level associated with distance based on the first navigation direction to indicate that a right turn is coming up in 1 mile. Thereafter, the navigation sensory guide program 160 may identify and interpret a real-time second navigation direction that includes “in 1000 feet, take the right 2 lanes to turn right onto I-880,” to indicate that the vehicle is getting closer to the right turn. Accordingly, the navigation sensory guide program 160 may include programming/code to associate the distance of 1000 feet with a certain decibel level that may be louder (with regard to volume) than the decibel level associated with 1 mile as well as associate 1000 feet with a certain number of sounds (3 “beeps”) generated at one time that is greater than the number of sounds associated with the distance of 1 mile from the turn. Therefore, the navigation sensory guide program 160 may generate an electrical communication to specifically emit a sound of 3 “beeps” from the second speaker 304B at an increased decibel level based on the second navigation direction to indicate that a right turn is approaching in 1000 feet. Additionally, in response to the navigation sensory guide program 160 detecting that the vehicle reaches a turn (such as by detecting that a vehicle is within 100 feet of a turn based on the navigation direction data), then the navigation sensory guide program 160 may generate an electrical communication to the second speaker 304B to further increase the decibel level of sounds and/or to emit a pattern of sound until the vehicle reaches 0 feet within the turn, whereby generating the electric communication for the second speaker 304B to emit a pattern of sound may include programming/code to emit “beeps” at least 3 times per second to cause the second speaker 304B to provide a sequence/pattern of sound until 0 feet is reached. The above examples provide only illustrations of one implementation of the sound indicator component 304A. 304B and does not imply any limitations with regard to how different embodiments may be implemented with respect to the position, number of sound components, and decibels levels as well as number of sounds associated with distances.

In addition to the light indicator component 302A, 302B and the sound indicator component 304A, 304B as previously described, the navigation sensory guide program 160 may be integrated with a vehicle component such as the vibration indicator component 306A, 306B, 306C, 306D (FIGS. 3A and 3B) which may also be associated/integrated with the in-vehicle computer system. According to one embodiment, the vibration indicator component 306A, 306B, 306C, 306D may include one or more vibration mechanisms/sensors associated with a vehicle as depicted in FIGS. 3A and 3B. Furthermore, similar to the light indicator component 302A, 302B and the sound indicator component 304A, 304B, the vibration indicator component 306A, 306B, 306C, 306D may include one or more vibration emitting devices, such as vibration mechanisms 306A, 306B, 306C, 306D which may emit one or more vibrations to indicate an upcoming turn and distance to the upcoming turn based on the navigation direction data. For example, and as depicted in FIG. 3A, the vibration indicator component 304A, 304B may include 2 vibration emitting devices that may include a first vibrating mechanism 306A positioned at a leftmost side of a vehicle steering wheel 318 and a second vibrating mechanism 306B that may be positioned at a rightmost side of the vehicle steering wheel 318. Also, according to one embodiment, and as depicted in FIG. 3B, the vibration indicator component may include 2 vibration emitting devices that may include a third vibrating mechanism 306C positioned at a leftmost side of a driver's side seat 320 and a fourth vibrating mechanism 306D that may be positioned at a rightmost side of the driver's side seat 320. Furthermore, according to one embodiment, and as will be further described, the first and third vibrating mechanisms 306A, 306C positioned at the leftmost side of the vehicle steering wheel 318 and driver's side seat 320, respectively, may indicate that a left turn may be approaching by emitting vibrations based on the navigation direction data identified and received at step 202. Similarly, the second and fourth vibrating mechanisms 306B, 306D positioned at the rightmost side of the vehicle steering wheel 318 and driver's side seat 320, respectively, may indicate that a right turn may be approaching by emitting vibrations based on the identified and received navigation direction data. According to another embodiment, the vibration indicator component may be a single vibration emitting device (not shown) that may be positioned on the steering wheel 318 and/or the driver's side seat 320, whereby the single vibration emitting device may emit vibration to indicate a turn.

As previously described, the vibration indicator component 306A, 306B, 306C, 306D may include one or more vibration emitting devices that may emit vibrations at various intensities as well as at various times to indicate an upcoming turn and a distance from the upcoming turn. Specifically, and as previously described with reference to the above example, in response to receiving and identifying the navigation direction data, the navigation sensory guide program 160 may translate/convert the navigation direction data into different electrical communications to different vehicle components that may include the light indicator component 302A, 302B and the sound indicator component 304A, 304B (as described above) as well as the vibration indicator component 306A, 306B, 306C, 306D. For example, and as previously described, based on entry of a destination using a mobile device or in-vehicle computer system, a navigation service provider may provide navigation direction data that may include a direction such as “in 1000 feet, take the right 2 lanes to turn right onto I-880.” As such, and according to one embodiment, the navigation sensory guide program 160 may include programming/code to concurrently convert the direction into electrical communications to the light indicator component 302A, 302B, the sound indicator component 304A, 304B (as described above), as well as to the vibration indicator component 306A, 306B, 306C, 306D whereby the electrical communication for the vibration indicator component 306A, 306B, 306C, 306D may include programming/code for a vibration emitting device to emit a certain amount of vibrations and/or emit vibrations at a certain intensity based on the distance to the right turn.

More specifically, for example, the navigation sensory guide program 160 may include natural language processing and/or machine learning to identify and interpret the instruction, “in 1000 feet, take the right 2 lanes to turn right onto I-880,” as an instruction to make a right turn in 1000 feet. Accordingly, the navigation sensory guide program 160 may include programming/code to automatically and specifically associate the right turn with a rightmost vibration emitting device which may include the second and fourth vibration mechanisms 306B, 306D in FIGS. 3A and 3B as previously described above. Conversely, the navigation sensory guide program 160 may include programming/code to specifically associate a left turn with a leftmost sound emitting device which may include the first and third vibration mechanisms 306A, 306C as previously described in FIGS. 3A and 3B. Furthermore, the navigation sensory guide program 160 may include programming/code to associate certain distances with a certain number of vibrations and/or a corresponding vibration intensity for a vibration mechanism. For example, the navigation sensory guide program 160 may include programming/code to associate a distance of 1000 feet with a vibration intensity that may be greater than the vibration intensity associated with a distance of 1 mile due to a turn that has an upcoming distance of 1000 feet being closer in distance than a turn in 1 mile. In other words, the navigation sensory guide program 160 may directly correlate the vibration intensity of a vibration mechanism with a derived to an upcoming turn based on the navigation direction data to indicate that distance from the upcoming turn, whereby as a vehicle approaches or becomes closer in distance to a turn then the vibration intensity correspondingly increases for the vibration mechanism to indicate that the vehicle is getting closer to the turn. Additionally, or alternatively, the navigation sensory guide program 160 may include programming/code to associate a distance of 1000 feet with a certain number of vibrations generated within a small time (for example, emitting 3 “vibrations” in 1.5 second) which may be greater than the number of vibrations associated with a distance of 1 mile (2 “vibrations” in 1 second) due to a turn that is in 1000 feet being closer in distance than a turn in 1 mile. In other words, the navigation sensory guide program 160 may directly correlate the number of vibrations emitted at one time from a vibration mechanism with a measure of distance derived from the navigation direction data to indicate a distance from an upcoming turn, whereby as a vehicle approaches or becomes closer in distance to a turn then the number of vibrations emitted from the vibration mechanism may correspondingly increase to indicate that the vehicle is getting closer to the turn.

For example, and as previously described, the navigation sensory guide program 160 may include natural language processing and/or machine learning to identify and interpret a first navigation direction including, “in 1 mile, take the right 2 lanes to turn right onto I-880,” as making an instruction to turn right in 1 mile. Accordingly, and as depicted in FIG. 3A, the navigation sensory guide program 160 may include programming/code for generating an electrical communication to specifically emit vibrations from the rightmost vibration mechanism associated with the vehicle steering wheel 318, which may include the second vibration mechanism 306B, to indicate a right turn. Furthermore, the navigation sensory guide program 160 may include programming/code to associate a distance of 1 mile with a certain a certain number of vibrations (i.e. 2 vibrations within 1 seconds) as well as a certain vibration intensity, and therefore, the electrical communication may further include programming/code to specifically emit 2 vibrations from the second vibration mechanism 306B at the certain vibration intensity associated with 1 mile to indicate that a right turn is coming up in 1 mile. Thereafter, the navigation sensory guide program 160 may identify and interpret a real-time second navigation direction that includes “in 1000 feet, take the right 2 lanes to turn right onto I-880,” to indicate that the vehicle is getting closer to the right turn. Accordingly, the navigation sensory guide program 160 may include programming/code to associate the distance of 1000 feet with a certain number of vibrations (i.e. 3 vibrations within 1.5 seconds) as well as a certain vibration intensity greater than the intensity associated with 1 mile, and therefore, the electrical communication may further include programming/code to specifically emit 3 vibrations from the second vibration mechanism 306B at the greater vibration intensity associated with 1000 feet to indicate that a right turn is coming up in 1000 feet. Additionally, in response to the navigation sensory guide program 160 detecting that the vehicle reaches a turn (such as by detecting that a vehicle is within 100 feet of a turn based on the navigation direction data), then the navigation sensory guide program 160 may generate an electrical communication to the second vehicle emitting device 306B to further increase the vibration intensity and/or may emit a pattern of vibrations until the vehicle reaches 0 feet within the turn, whereby generating the electric communication for the second vibration mechanism 306B to emit a pattern of vibrations may include programming/code to emit vibrations at least 3 times per second to cause the second vibration mechanism 304B to provide a sequence/pattern of vibrations until 0 feet is reached. The above examples provide only illustrations of one implementation of the vibration indicator component 304A, 304B and does not imply any limitations with regard to how different embodiments may be implemented with respect to the position, number of sound components, and decibels levels as well as number of sounds associated with distances.

Furthermore, and as previously described at step 204, the navigation sensory guide program 160 may translate/convert audio content and displayable content associated with the identified and received navigation direction data into a second type, or alternative type, of audio content and displayed content that may include simpler, more reduced forms of audio content and displayed content. As previously described, typically, for map-based displays that further include audio content, the navigation directions may include displayable content such as a vehicle presented on a geographical map associated with a navigation interface and further include audio content such as “in 1 mile, take the right 2 lanes to turn right onto I-880” and “in 1000 feet, take the right 2 lanes to turn right onto 1-880.” Specifically, a vehicle's location can be monitored on a vehicle component such as a vehicle display screen that may include a map-based navigation interface that monitors the vehicle as the vehicle moves in relation to landmarks such as streets, hotels, gas stations, and restaurants which may be depicted on the geographical map, and routes to different destinations may further be calculated using the navigation interface. However, and as previously described, such current navigation interfaces may distract drivers from the road. Specifically, navigation systems including map-based navigation interfaces may be distracting and complicated due to an overwhelming amount of landmarks as well as other map components and controls that may be displayed on the navigation interface. Similarly, voice directions are complex and may require an overwhelming amount of cognitive data to be loaded by the navigation interface in order to provide turn-by-turn directions that include landmark descriptions such as road and street descriptions. As such, the present invention may provide a simpler and more streamlined process for presenting navigation directions to a user based on the vehicle components described above, as well as by translating/converting typical audio content and displayable content associated with the identified and received navigation direction data into simpler, more reduced forms of audio content and displayed content. More specifically, the present invention may automatically convert the audio content and displayable content associated with the identified and received navigation direction data into a second type of audio content and a second type of displayed content, wherein automatically converting the audio content and the displayable content further comprises altering and/or removing map-based content associated with a navigation interface, reducing natural language associated with the audio content and the displayable content, and only displaying the reduced natural language in response to a direction from the navigation direction data.

For example, for the navigation direction data that includes audio content and displayable content associated with a first navigation direction such as “in 1 mile, take the right 2 lanes to turn right onto I-880,” the navigation sensory guide program 160 may use natural language processing and machine learning algorithms to identify that the navigation direction is a right turn that is approaching in 1 mile. According to one embodiment, the navigation sensory guide program 160 may also generate and associate certain natural language with certain distances of a turn. For example, for turns having a distance that is equal to or greater than 1 mile, the navigation sensory guide program 160 may identify the direction and/or lane necessary for completing the turn based on the navigation direction data and then may generate natural language to be provided as audio as well as displayed on a vehicle's display screen 322 that simply includes the lane that the vehicle must be in to complete the turn, such as “right lane” as displayed in FIG. 3A. In other words, the navigation sensory guide program 160 may directly correlate the natural language that is generated and displayed for conveying a turn with the identified direction as well as distance of the turn derived from the navigation direction data, whereby as a vehicle approaches or becomes closer in distance to a turn then the amount and/or specificity of natural language (i.e. description) used to identify the turn may correspondingly increase to indicate that the vehicle is at or getting close to the turn. Thus, for example, while “right lane” may be associated with and displayed for right turns having a distance equal to or greater than 1 mile, for a second navigation direction such as “in 1000 feet, take the right 2 lanes to turn right onto I-880,” the navigation sensory guide program 160 may again identify the turn and distance, and then may generate and use more descriptive natural language such as “right in 1000 feet” to identify the turn because the turn is closer in distance as depicted on vehicle display screen 322 in FIG. 3B. Additionally, in response to the navigation sensory guide program 160 detecting that the vehicle reaches a turn (such as by detecting that a vehicle is within 500 feet of a turn based on the navigation direction data), then the navigation sensory guide program 160 may generate and display natural language that specifically describes the road such as by audibly presenting and displaying “right on I-880.”

Thus, in turn, and as depicted at 206 in FIG. 2, the navigation sensory guide program 160 may automatically provide real-time navigation directions by transmitting/relaying the electrical communications based on the navigation direction data to the different vehicle components including one or more combinations of the light indicator component, the sound indicator component, and the vibration indicator component, as well as may present translated/reduced forms of audio content and displayable content corresponding to the navigation direction data. Furthermore, according to one embodiment, the navigation sensory guide program 160 may include a user interface for enabling and disabling receiving navigation directions from the one or more vehicle components. For example, a driver/user may wish to receive navigation directions only from the light indicator component 302A, 302B, or from a combination of the light indicator component 302A, 302B and the vibration indicator component 306A, 306B, 306C, 306D, or from the translated/converted navigation direction data that is displayed on the vehicle display screen 322, or from a combination of the light indicator component 302A, 302B, the sound indicator component 304A, 304B, and the vibration indicator component 306A, 306B, 306C, 306D, or from a combination of all of the above. As such, the navigation sensory guide program 160 may provide the user interface for enabling and disabling navigation directions received from the one or more vehicle components to indicate a type of navigation directions the driver wishes to receive.

It may be appreciated that FIGS. 2-3B provide only illustrations of one implementation and does not imply any limitations with regard to how different embodiments may be implemented. Many modifications to the depicted environments may be made based on design and implementation requirements.

As previously described, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Furthermore, machine learning as described herein may broadly refer to machine learning algorithms that learn from data. More specifically, machine learning is a branch of artificial intelligence that relates to algorithms such as mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusters, such as k-means clusters, mean-shift clusters, and spectral clusters; (v) factorization machines, principal component analyzers and kernel principal component analyzers; and (vi) ensembles or other combinations of machine-learning models. Neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

What is claimed is:

1. A computer-implemented method for automatically providing real-time navigation directions using one or more vehicle components, comprising:
in response to receiving and identifying navigation direction data from a navigation service provider, converting the navigation direction data into different electrical communications to different vehicle components that may include one or more combinations of a light indicator component, a sound indicator component, and a vibration indicator component associated with a vehicle; and
automatically presenting the real-time navigation directions using the different vehicle components by automatically transmitting the electrical communications based on the navigation direction data to the one or more combinations of the light indicator component, the sound indicator component, and the vibration indicator component.

2. The computer-implemented method of claim 1, wherein automatically transmitting the electrical communications based on the navigation direction data to the light indicator component further comprises:
automatically correlating a brightness of a light emitting device associated with the light indicator component with a distance to an upcoming turn based on the navigation direction data to indicate the distance to the upcoming turn, wherein automatically corelating the brightness with the distance further comprises increasing the brightness of the light emitting device as the distance decreases between the vehicle and the upcoming turn.

3. The computer-implemented method of claim 1, wherein automatically transmitting the electrical communications based on the navigation direction data to the sound indicator component further comprises:
automatically correlating a volume and a number of sounds for a sound emitting device associated with the sound indicator component with a distance to an upcoming turn based on the navigation direction data to indicate the distance to the upcoming turn, wherein automatically corelating the volume and the number of sounds with the distance further comprises increasing the volume and the number of sounds of the sound emitting device as the distance decreases between the vehicle and the upcoming turn.

4. The computer-implemented method of claim 1, wherein automatically transmitting the electrical communications based on the navigation direction data to the vibration indicator component further comprises:
automatically correlating a vibration intensity and a number of vibrations for a vibration emitting device associated with the vibration indicator component with a distance to an upcoming turn based on the navigation direction data to indicate the distance to the upcoming turn, wherein automatically corelating the vibration intensity and the number of vibrations with the distance further comprises increasing the vibration intensity and the number of vibrations of the vibration emitting device as the distance decreases between the vehicle and the upcoming turn.

5. The computer-implemented method of claim 1, further comprising:
automatically converting audio content and displayable content associated with the identified and received navigation direction data into a second type of audio content and a second type of displayed content, wherein automatically converting the audio content and the displayable content further comprises removing map-based content associated with a navigation interface, reducing natural language associated with the audio content and the displayable content, and only displaying the reduced natural language in response to a direction from the navigation direction data.

6. The computer-implemented method of claim 1, further comprising:
wherein the light indicator component comprises a first light emitting device corresponding to a left turn associated with the navigation direction data and a second light emitting device corresponding to a right turn associated with the navigation direction data;
wherein the sound indicator component comprises a first sound emitting device corresponding to the left turn and a second sound emitting device corresponding to the right turn; and
wherein the vibration indicator component comprises a first vibration mechanism corresponding to the left turn and a second vibration mechanism corresponding to the right turn.

7. The computer-implemented method of claim 1, wherein a location of the vibration indicator component is selected from at least one of a steering wheel and a driver seat.

8. A computer system for automatically providing real-time navigation directions using one or more vehicle components, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
in response to receiving and identifying navigation direction data from a navigation service provider, converting the navigation direction data into different electrical communications to different vehicle components that may include one or more combinations of a light indicator component, a sound indicator component, and a vibration indicator component associated with a vehicle; and
automatically presenting the real-time navigation directions using the different vehicle components by automatically transmitting the electrical communications based on the navigation direction data to the one or more combinations of the light indicator component, the sound indicator component, and the vibration indicator component.

9. The computer system of claim 8, wherein automatically transmitting the electrical communications based on the navigation direction data to the light indicator component further comprises:
automatically correlating a brightness of a light emitting device associated with the light indicator component with a distance to an upcoming turn based on the navigation direction data to indicate the distance to the upcoming turn, wherein automatically corelating the brightness with the distance further comprises increasing the brightness of the light emitting device as the distance decreases between the vehicle and the upcoming turn.

10. The computer system of claim 8, wherein automatically transmitting the electrical communications based on the navigation direction data to the sound indicator component further comprises:
automatically correlating a volume and a number of sounds for a sound emitting device associated with the sound indicator component with a distance to an upcoming turn based on the navigation direction data to indicate the distance to the upcoming turn, wherein automatically corelating the volume and the number of sounds with the distance further comprises increasing the volume and the number of sounds of the sound emitting device as the distance decreases between the vehicle and the upcoming turn.

11. The computer system of claim 8, wherein automatically transmitting the electrical communications based on the navigation direction data to the vibration indicator component further comprises:
automatically correlating a vibration intensity and a number of vibrations for a vibration emitting device associated with the vibration indicator component with a distance to an upcoming turn based on the navigation direction data to indicate the distance to the upcoming turn, wherein automatically corelating the vibration intensity and the number of vibrations with the distance further comprises increasing the vibration intensity and the number of vibrations of the vibration emitting device as the distance decreases between the vehicle and the upcoming turn.

12. The computer system of claim 8, further comprising:
automatically converting audio content and displayable content associated with the identified and received navigation direction data into a second type of audio content and a second type of displayed content, wherein automatically converting the audio content and the displayable content further comprises removing map-based content associated with a navigation interface, reducing natural language associated with the audio content and the displayable content, and only displaying the reduced natural language in response to a direction from the navigation direction data.

13. The computer system of claim 8, further comprising:
wherein the light indicator component comprises a first light emitting device corresponding to a left turn associated with the navigation direction data and a second light emitting device corresponding to a right turn associated with the navigation direction data;
wherein the sound indicator component comprises a first sound emitting device corresponding to the left turn and a second sound emitting device corresponding to the right turn; and
wherein the vibration indicator component comprises a first vibration mechanism corresponding to the left turn and a second vibration mechanism corresponding to the right turn.

14. The computer system of claim 8, wherein a location of the vibration indicator component is selected from at least one of a steering wheel and a driver seat.

15. A computer program product for automatically providing real-time navigation directions using one or more vehicle components, comprising:
one or more tangible computer-readable storage devices and program instructions stored on at least one of the one or more tangible computer-readable storage devices, the program instructions executable by a processor, the program instructions comprising:
in response to receiving and identifying navigation direction data from a navigation service provider, converting the navigation direction data into different electrical communications to different vehicle components that may include one or more combinations of a light indicator component, a sound indicator component, and a vibration indicator component associated with a vehicle; and
automatically presenting the real-time navigation directions using the different vehicle components by automatically transmitting the electrical communications based on the navigation direction data to the one or more combinations of the light indicator component, the sound indicator component, and the vibration indicator component.

16. The computer program product of claim 15, wherein automatically transmitting the electrical communications based on the navigation direction data to the light indicator component further comprises:
automatically correlating a brightness of a light emitting device associated with the light indicator component with a distance to an upcoming turn based on the navigation direction data to indicate the distance to the upcoming turn, wherein automatically corelating the brightness with the distance further comprises increasing the brightness of the light emitting device as the distance decreases between the vehicle and the upcoming turn.

17. The computer program product of claim 15, wherein automatically transmitting the electrical communications based on the navigation direction data to the sound indicator component further comprises:
automatically correlating a volume and a number of sounds for a sound emitting device associated with the sound indicator component with a distance to an upcoming turn based on the navigation direction data to indicate the distance to the upcoming turn, wherein automatically corelating the volume and the number of sounds with the distance further comprises increasing the volume and the number of sounds of the sound emitting device as the distance decreases between the vehicle and the upcoming turn.

18. The computer program product of claim 15, wherein automatically transmitting the electrical communications based on the navigation direction data to the vibration indicator component further comprises:
automatically correlating a vibration intensity and a number of vibrations for a vibration emitting device associated with the vibration indicator component with a distance to an upcoming turn based on the navigation direction data to indicate the distance to the upcoming turn, wherein automatically corelating the vibration intensity and the number of vibrations with the distance further comprises increasing the vibration intensity and the number of vibrations of the vibration emitting device as the distance decreases between the vehicle and the upcoming turn.

19. The computer program product of claim 15, further comprising:
automatically converting audio content and displayable content associated with the identified and received navigation direction data into a second type of audio content and a second type of displayed content, wherein automatically converting the audio content and the displayable content further comprises removing map-based content associated with a navigation interface, reducing natural language associated with the audio content and the displayable content, and only displaying the reduced natural language in response to a direction from the navigation direction data.

20. The computer program product of claim 15, further comprising:
wherein the light indicator component comprises a first light emitting device corresponding to a left turn associated with the navigation direction data and a second light emitting device corresponding to a right turn associated with the navigation direction data;
wherein the sound indicator component comprises a first sound emitting device corresponding to the left turn and a second sound emitting device corresponding to the right turn; and
wherein the vibration indicator component comprises a first vibration mechanism corresponding to the left turn and a second vibration mechanism corresponding to the right turn.
